(19) United States
(12) Patent Application Publication
(10) Pub. No.: US 2017/0211283 A1
(43) Pub. Date: Jul. 27, 2017

(54) TRESTLE LADDER SYSTEMS AND METHOD

(71) Applicant: ANTHONY SOMMER, ROME, GA (US)

(72) Inventor: ANTHONY SOMMER, ROME, GA (US)

(21) Appl. No.: 15/413,397

(22) Filed: Jan. 23, 2017

Related U.S. Application Data
(60) Provisional application No. 62/281,246, filed on Jan. 21, 2016.

(51) Int. Cl. E04G 1/30; E04G 5/08; E06C 1/18; E04G 5/14

(52) U.S. Cl. CPC E04G 1/30; E04G 5/14; E04G 5/08; E06C 1/18; E04G 2001/307

(57) ABSTRACT

A trestle ladder system including at least two ladder assemblies, at least one plank assembly, and a handrail assembly. Each ladder assembly including four side-rails, two hinge assemblies, and a plurality of rungs. Each plank assembly is removably placeable upon the rungs to provide a working platform. The handrail assembly is removably coupleable to each of the ladder assemblies to provide additional safety to the user during use and the trestle ladder system is configured to provide a working platform for the user to perform a task elevated from the ground surface in a safe an efficient manner Included are support-feet which are removable, replaceable, and extendable such that the system can accommodate uneven ground.

### CROSS-REFERENCE TO RELATED APPLICATION

The present application is related to and claims priority to U.S. Provisional Patent Application Number 62/281246 filed Jan. 21, 2016, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. FIELD OF THE INVENTION

The present invention relates generally to the field of platforms of the existing art, and more specifically relates to ladders and scaffolding.

### 2. DESCRIPTION OF RELATED ART

Stepladders are often used to work on painting or maintenance tasks above an arm's reach from the ground. Stepladders can often be dangerous or unsafe, risking a fall for the user which may cause serious injury or possible death. Using a conventional stepladder forces an individual to move the ladder constantly in order to work on different portions of the building. Further, larger extension ladders may be used for these types of jobs; however, these ladders can be extremely heavy and difficult for one person to erect.

In some applications, scaffolding may be used to perform work tasks above the ground. Scaffolding is generally erected in longer sections such that a larger area of a building or other work surface may be reached by a user without the need to frequently move the scaffolding. Scaffolding can be difficult to erect, as in many instances more than one individual is needed to erect the scaffold. Also, scaffolding can be cumbersome and rarely allows the user to work at a variety of heights. A suitable solution is desired.

U.S. Pat. No. 5,332,062 to Paul Revere which relates to a scaffold ladder. The described scaffold ladder includes a combination scaffold ladder device having a scaffold portion which is formed by a prop positioned above a pair of ladder side members, and is connected to the sides by a connecting means. The side connecting includes: a top step and a pair of extensible spreaders. The parallel ladder side members each contain at least one indentation, and are joined together by a plurality of ladder steps with two of the steps being partial in nature. By placing the scaffold on its side or in a vertical position and releasing the locking means on the extensible spreaders by pivoting the versatile support members by means of pivoting joining pins into the indentations of the parallel ladder side members simultaneously joining two partial step/pullout bars of the versatile support members with their mating partial steps on the ladder structure in a parallel manner forming complete steps and transforming the invention into a flat horizontal platform. The vertical placement of the ladder structure away from the prop through the use of extensible spreaders affords the invention its stepladder configuration.

### BRIEF SUMMARY OF THE INVENTION

In view of the foregoing disadvantages inherent in the known ladders and scaffolding art, the present disclosure provides a novel trestle ladder systems and method. The general purpose of the present disclosure, which will be described subsequently in greater detail, is to provide a trestle ladder and method for use to provide a user with an elevated work surface such that the user may perform a task from a position elevated from a ground surface in a safe and efficient manner

A trestle ladder system is disclosed herein. The trestle ladder system includes at least two ladder assemblies, at least one plank assembly, and a handrail assembly. Each ladder assembly preferably includes four side-rails, two hinge assemblies, and a plurality of rungs; with each of the two side-rails including an upper-end and a lower end, with the two side-rails arranged in a similar geometric plane.

The plurality of rungs is arranged between each of the two side-rails, with the plurality of rungs arranged in a substantially vertical plane relative to a ground surface. The plurality of rungs is preferably equally spaced (e.g., in one foot intervals, etc.) The hinge assembly is coupled to each of the two side-rails nearest the upper-end of the two side-rails at a position where each single plane of each side-rail meet such that each ladder assembly forms a substantially triangular arrangement. Each of the side-rails of the ladder assembly are modular such that the side-rails are comprised of two or more pieces each, with the two pieces of the side-rails removably detachable via pins or the like.

Each plank assembly includes (is defined by) a top-side, a bottom-side, two ends, and a perimeter, with each of the at least one plank assemblies removably placeable upon the rungs of the at least two ladder assemblies to provide a working platform for a user to perform a work-related task.

The handrail assembling includes a top-bar, a bottom-bar, and two vertical-bars, each of the top-bars and the bottom-bars removably coupleable to each of the vertical-bars. The handrail assembly is removably coupleable to each of the ladder assemblies to provide additional safety to the user during use and the trestle ladder system is structured and arranged to provide a working platform for the user to perform a task elevated from the ground surface in a safe an efficient manner

Embodiments of trestle ladder system also can include support-feet which are removable and replaceable, with the support-feet being extendable and adjustable such that the system can accommodate an uneven ground surface.

According to another embodiment, a method of using a trestle ladder system is also disclosed herein. The method of use includes a first step, providing a trestle ladder system comprising at least two ladder assemblies, at least one plank assembly, and handrail assembly; a second step, placing at least two ladder assemblies of the trestle ladder system adjacent to a work surface; a third step, placing the plank assembly upon the trestle ladder assembly; a fourth step, affixing the handrail assembly to the ladder assemblies; a fifth step, completing a work-related task; a sixth step, removing the handrail assembly from the ladder assemblies; a seventh step, removing the plank assembly from trestle ladder assembly; and an eighth step, removing the trestle ladder assembly. It must be noted that not all steps need be implemented in all cases, and not all steps of the method of use are required.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a trestle ladder system and method, constructed and operative according to the teachings of the present disclosure.

FIG. 1 is a perspective view of the trestle ladder system during an ‘in-use’ condition, according to an embodiment of the disclosure.

FIG. 2 is a perspective view of the trestle ladder system of FIG. 1, according to an embodiment of the present disclosure.

FIG. 3A is a side view of the trestle ladder system of FIG. 1, according to an embodiment of the present disclosure.

FIG. 3B is a front view of the trestle ladder system of FIG. 1, according to an embodiment of the present disclosure.

FIG. 4 is a perspective view of the trestle ladder system of FIG. 1, according to an embodiment of the present disclosure.

FIG. 5 is a flow diagram illustrating a method of use for a trestle ladder system, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to ladders and scaffolding, and more particularly to a trestle ladder system and method as used to improve the ability of a user to perform a work related task above a ground surface, despite the ground surface contour.

Generally, a trestle ladder system may be used for painting or construction at an elevated height. The system uses a pair of trestle ladders to support a plank for the user to work from. The trestle ladders comprise a frame that appears similar to a step ladder, except that the base is significantly wider and the rungs are staggered on each side to provide a step increase of one foot. The trestle may be provided in incremental eight-foot sections such that the user may lock them together to create a sixteen-foot tall system.

The trestle may further include adjustable feet to accommodate an uneven ground surface. The system also comprises a safety railing for work at elevated heights above six feet. The system is erected by laying the top section on its side and opening it to thirty degrees. The bottom extensions and feet are then attached. The setup is repeated for the second trestle. The user can then insert a wooden or aluminum plank into the system and can climb the trestle to work from the plank. For increased plank height, the user may reinstall the plank at a higher elevation. The system allows the user to work over a much larger area than can be done with a standard ladder system and is more quickly set up than the typical scaffolding systems.

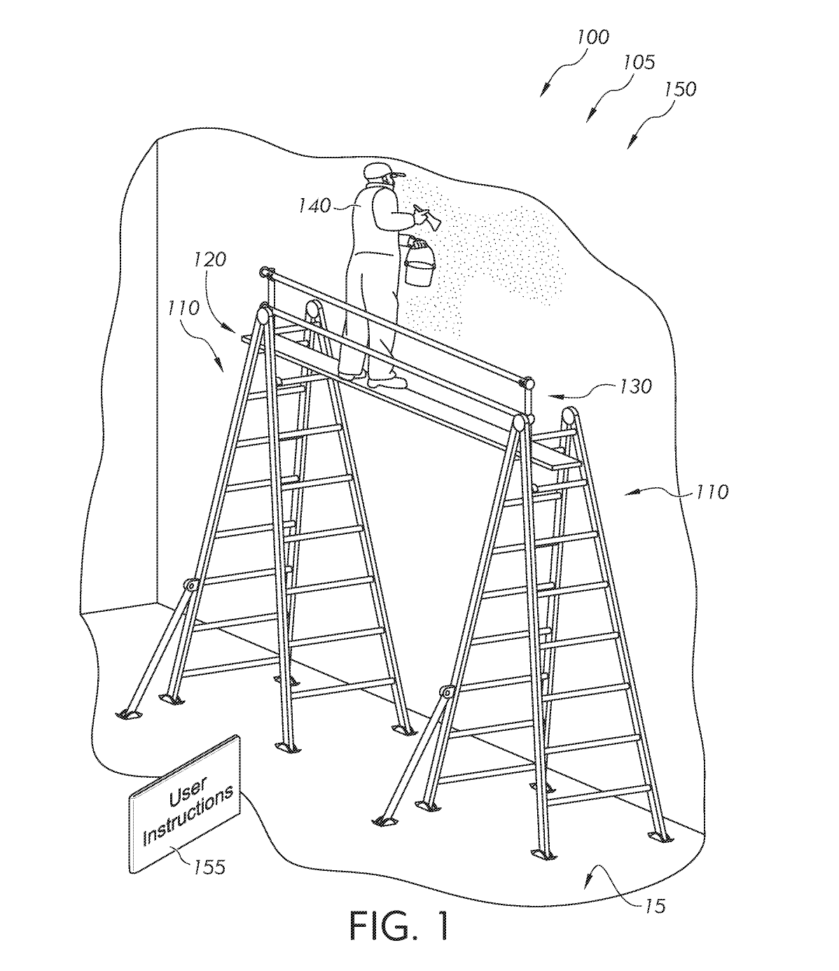

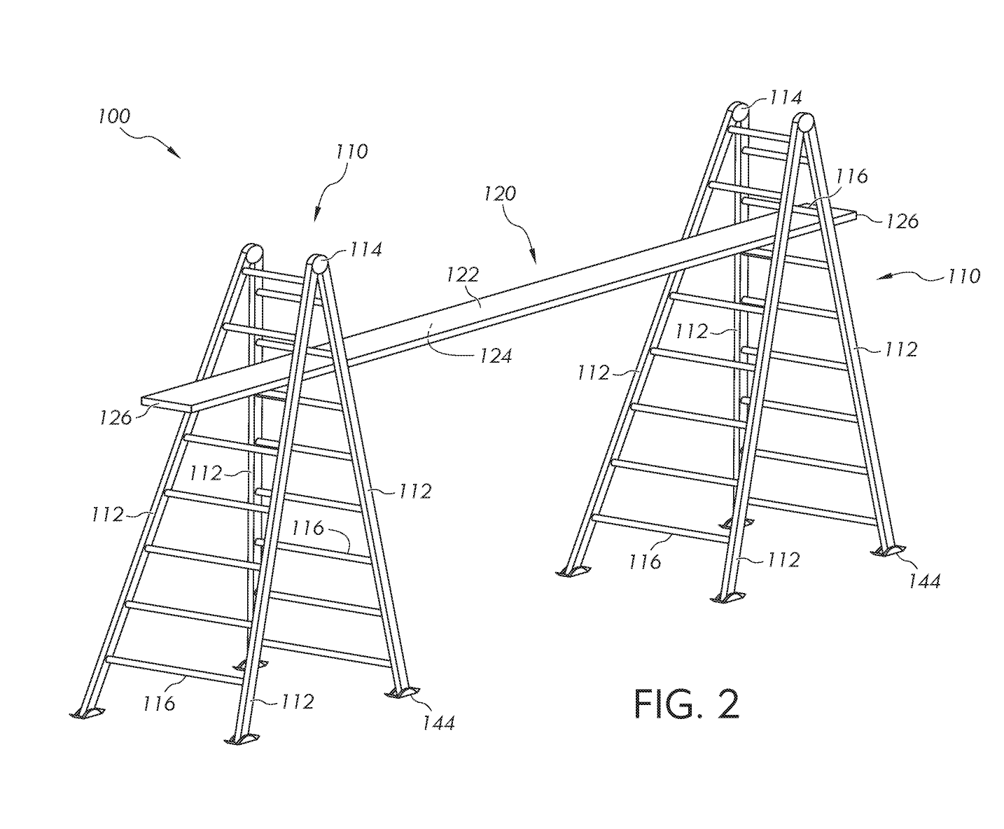

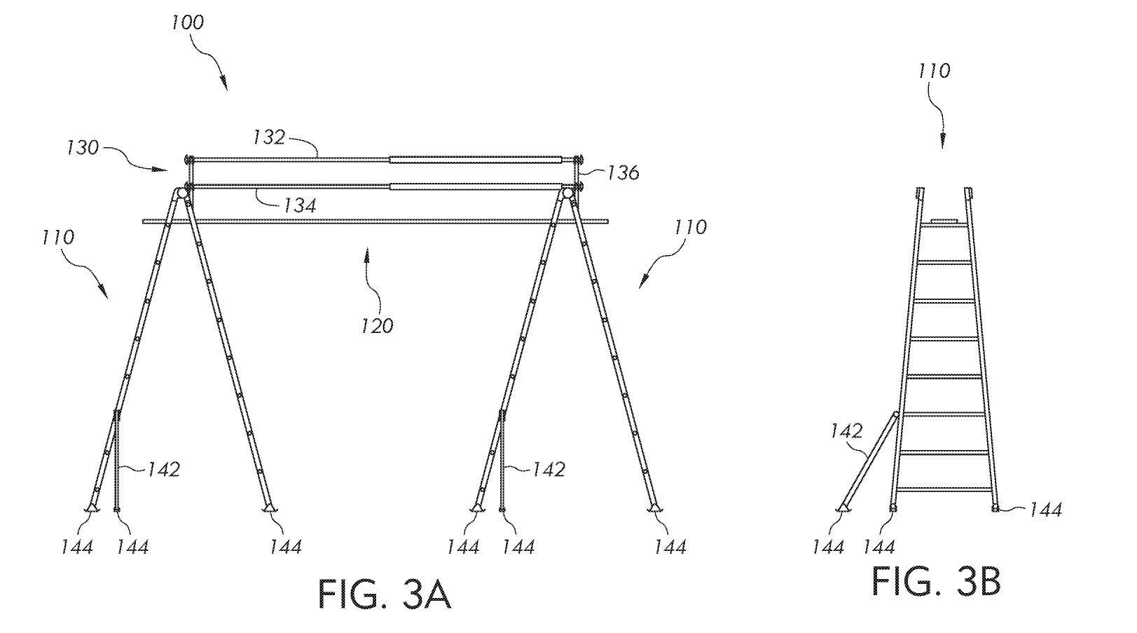

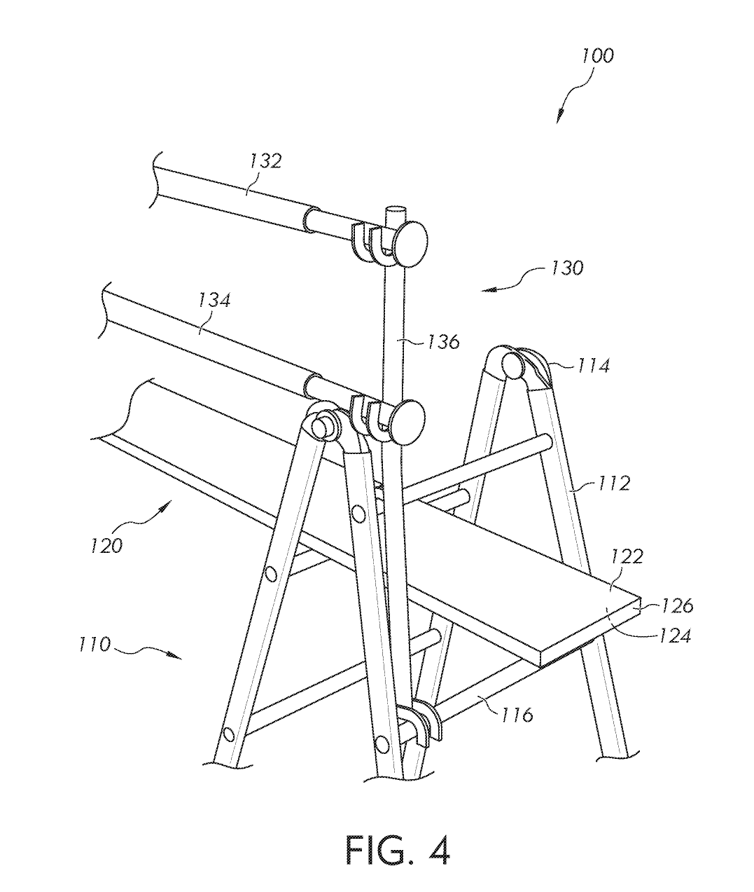

Referring now more specifically to the drawings by numerals of reference, there is shown in FIGS. 1-4, various views of a trestle ladder system 100. FIG. 1 shows a trestle ladder system 100 during an ‘in-use’ condition 150, according to an embodiment of the present disclosure. Here, the trestle ladder system 100 may be beneficial for use by a user 140 to allow a user to perform a work-related task above a ground surface at varying heights. As illustrated, the trestle ladder system 100 may include at least two ladder assemblies 110, at least one plank assembly 120, and handrail assembly 130.

As shown in FIGS. 1-4, each ladder assembly 110 may comprise four side-rails 112, two hinge assemblies 114, and plurality of rungs 116. Each two side-rails 112 may include an upper-end and a lower end, with each side-rail 112 arranged in a similar geometric plane, with plurality of rungs 116 arranged between each side-rail 112. The plurality of rungs 116 may be arranged in a substantially vertical plane relative to ground surface 15, and hinge assembly 114 coupled to each side-rail 112 nearest the upper-end of each side-rail 112 at a position where each single plane of each side-rail 112 meet, such that each ladder assembly 110 forms a substantially triangular arrangement.

Embodiments may include rungs 116 of ladder assembly equally spaced in a horizontal direction, with other embodiments including rungs 116 at alternate spacing, (e.g., rung 116 spacing increases from the lower-end to the upper-end of side-rail 112 at a predetermined interval, decreases from lower-end to upper-end, etc.).

Side-rail 112 of ladder assembly 110 may be modular such that side-rails 112 are comprised of two or more pieces each to provide varying heights of ladder assembly 100. Side-rail 112 of may be removably attachable via pins 146, in some embodiments. Additional embodiments may include side-rail 112 which is removably attachable via fasteners. Further embodiments may include additional forms of attachment, depending upon user preferences and specific use conditions. Suitable equivalents may be used.

Each ladder assembly 110 may include at least one support-member 142 hingeldy coupled to at least one side-rail 112 to provide additional support and stability to trestle ladder system 100 during use. Also shown, is plank assembly 120 which may include top-side 122, bottom-side 124, two ends 126, and perimeter128. Each plank assembly 120 may be removably placeable upon rungs 116 of at least two ladder assemblies 110 to provide a working platform for user 140 to perform a work-related task.

Handrail assembly 130 may include top-bar 132, bottom-bar 134, and vertical-bars, each of the top-bars and bottom-bars may be removably coupleable to vertical-bars 136. Handrail assembly 130 may be removably coupleable to each ladder assembly 110. Handrail assembly 130 may be constructed from a tubular material such that handrail assembly 130, and therefore trestle ladder system 100, may be configurable into multiple lengths to accommodate a wide variety of uses.

Embodiments of trestle ladder system 100 may additionally include support-feet 144 affixable to the lower end of one or more side-rail(s) 112 to provide additional stability and support to trestle ladder system 100 during use. Additional embodiments of trestle ladder system 100 may include support-feet 144 which may be removable and replaceable. Also, support feet-may 144 may be extendable such that trestle ladder system 100 may accommodate uneven ground surface 15. Support-feet 144 may also include a texturized surface to contact ground surface 15 to provide additional stability and support to trestle ladder system 100.

Embodiments of trestle ladder system 100 may be constructed from a variety of materials, or a combination of materials. Trestle ladder system 100 may include components constructed from a ferrous-metallic material such that trestle ladder system 100 is durable to improve longevity during use, may include an aluminum material such that trestle ladder system 100 is lightweight and durable, and/or a fiberglass material such that trestle ladder system 100 is not electrically conductive. Other materials may also be used.

Trestle ladder system 100 may be structured and arranged to provide a working platform for user 140 to perform a task elevated from ground surface in a safe an efficient manner.

According to one embodiment, the trestle ladder system 100 may be arranged as a kit 105. In particular, the trestle ladder system 100 may further include a set of instructions 155. The instructions 155 may detail functional relationships in relation to the structure of the trestle ladder system 100 (such that the trestle ladder system 100 can be used, maintained, or the like, in a preferred manner).

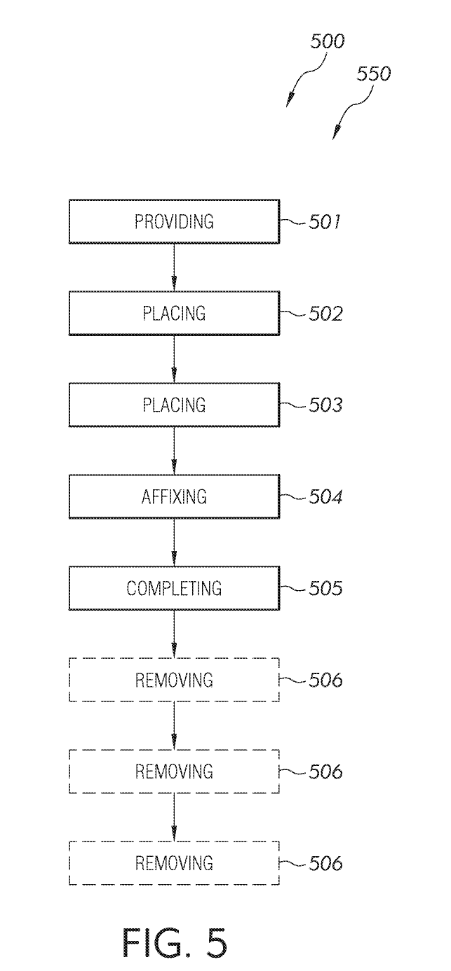

FIG. 5 is a flow diagram 550 illustrating a method for use 500 for a trestle ladder system 100, according to an embodiment of the present disclosure. In particular, the method 500 for using a trestle ladder system 100 may include one or more components or features of the trestle ladder system 100 as described above. As illustrated, the method for using 500 a trestle ladder system 100 may include the steps of: step one 501, providing trestle ladder system 100 comprising at least two ladder assemblies 110, at least one plank assembly 120, and handrail assembly 130; step two 502, placing at least two ladder assemblies 110 of trestle ladder system 100 adjacent to a work surface; step three 503, placing plank assembly 120 upon ladder assembly 110; step four 504, affixing handrail assembly 130 to ladder assemblies 110; step five 505, completing a work-related task; step six 506, removing handrail assembly 130 from ladder assemblies 110; step seven 507, removing plank 120 assembly from ladder assembly 110; and step eight 508, removing trestle ladder system 100.

It should be noted that step six 506, step seven 507, and step eight 508, are optional steps and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. §112(f). It should also be noted that, under appropriate circumstances, considering such issues as design preference, user preferences, marketing preferences, cost, structural requirements, available materials, technological advances, etc., other methods for using a trestle ladder system (e.g., different step orders within above-mentioned list, elimination or addition of certain steps, including or excluding certain maintenance steps, etc.), are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A trestle ladder system, the system comprising:
at least two ladder assemblies, each ladder assembly comprising four side-rails, two hinge assemblies, and a plurality of rungs, with each of said two side-rails including an upper-end and a lower end, with said two-side rails arranged in a similar geometric plane, with said plurality of rungs arranged between each of said two side-rails, the plurality of rungs arranged in a substantially vertical plane relative to a ground surface, said hinge assembly coupled to each of said two side-rails nearest said upper-end of said two side-rails at a position where each single plane of each said side-rail meet such that each ladder assembly forms a substantially triangular arrangement;
at least one plank assembly including a top-side, a bottom-side, two ends, and a perimeter, with each of said at least one plank assembly removably placeable upon said rungs of said at least two ladder assemblies to provide a working platform for a user to perform a work-related task; and
a handrail assembly, said handrail assembling comprising a top-bar, a bottom-bar, and two vertical-bars, each of said top-bars and said bottom-bars removably coupleable to each of said vertical-bars,
wherein said handrail assembly is removably coupleable to each of said ladder assemblies; and
wherein said trestle ladder system is structured and arranged to provide a working platform for said user to perform a task elevated from said ground surface in a safe and efficient manner

2. The trestle ladder system of claim 1, wherein each of the at least two ladder assemblies include at least one support-member hingeldy coupled to at least one said side-rail to provide additional support and stability during use.

3. The trestle ladder system of claim 1, further comprising support-feet affixable to said lower end of each said side-rail to provide additional stability and support to said trestle ladder system during use.

4. The trestle ladder system of claim 1, wherein each of said side-rails of said ladder assembly are modular such that said side-rails are comprised of two or more pieces each.

5. The trestle ladder system of claim 1, wherein each of said side-rails of said ladder assembly are modular such that said side-rails are comprised of two or more pieces each and removably attachable via pins.

6. The trestle ladder system of claim 1, wherein each of said side-rails of said ladder assembly are modular such that said side-rails are comprised of two or more pieces each and removably attachable via fasteners.

7. The trestle ladder system of claim 3, wherein said rungs of said ladder assembly are equally spaced in a horizontal direction.

8. The trestle ladder system of claim 1, wherein each of said rungs of said ladder assembly are sequentially spaced such that a rung spacing increases from said lower-end to said upper-end of said side-rails at a predetermined interval.

9. The trestle ladder system of claim 3, wherein said support-feet are removable and replaceable.

10. The trestle ladder system of claim 3, wherein said support-feet are extendable such that the trestle ladder system can accommodate an uneven ground surface.

11. The trestle ladder system of claim 3, wherein said support-feet include a texturized surface to contact said ground surface to provide additional stability and support to said trestle ladder system.

12. The trestle ladder system of claim 1, wherein said handrail assembly is constructed from a tubular shaped profile material such that said handrail assembly and therefore aid trestle ladder system being configurable into multiple lengths.

13. The trestle ladder system of claim 1, wherein said trestle ladder system is constructed from a carbon-fiber material such that said trestle ladder system is non-electrically conductive and lightweight for ease of use.

14. The trestle ladder system of claim 1, wherein said trestle ladder system is constructed from a ferrous-metallic material such that said trestle ladder system is durable to improve longevity during use.

15. The trestle ladder system of claim 1, wherein said trestle ladder system is constructed from an aluminum material such that said trestle ladder system is lightweight and durable.

16. The trestle ladder system of claim 1, wherein said trestle ladder system is constructed from a fiberglass material such that said trestle ladder system is not electrically conductive.

17. A trestle ladder system, the system comprising:
at least two ladder assemblies, each ladder assembly comprising four side-rails, two hinge assemblies, and a plurality of rungs, with each of said two side-rails including an upper-end and a lower end, with said two side-rails arranged in a similar geometric plane, with said plurality of rungs arranged between each of said two side-rails, the plurality of rungs arranged in a substantially vertical plane relative to a ground surface, said hinge assembly coupled to each of said two side-rails nearest said upper-end of said two side-rails at a position where each single plane of each said side-rail meet such that each ladder assembly forms a substantially triangular arrangement;
at least one plank assembly including a top-side, a bottom-side, two ends, and a perimeter, with each of said at least one plank assembly removably placeable upon said rungs of said at least two ladder assemblies to provide a working platform for a user to perform a work-related task;
a handrail assembly, said handrail assembling comprising a top-bar, a bottom-bar, and two vertical-bars, each of said top-bars and said bottom-bars removably coupleable to each of said vertical-bars;
support-feet affixable to said lower end of each side-rail to provide additional stability for gripping and support to said trestle ladder system during use;
wherein said handrail assembly is removably coupleable to each of said ladder assemblies;
wherein said trestle ladder system is structured and arranged to provide a working platform for said user to perform a task elevated from said ground surface in a safe an efficient manner;
wherein each of the at least two ladder assemblies includes at least one support-member hingeldy coupled to at least one said side-rail to provide additional support and stability during use;
wherein each of said side rails of said ladder assembly are modular such that said side-rails are comprised of two or more pieces each and removably attachable via pins;
wherein each of said side-rails of said ladder assembly are modular such that said side-rails are comprised of two or more pieces each and removably attachable via pins via fasteners;
wherein said support-feet are removable and replaceable;
wherein said support-feet are extendable such that the system can accommodate an uneven ground surface; and
wherein said support-feet include a texturized surface to contact said ground surface to provide additional stability and support to said trestle ladder system.

18. The trestle ladder system of claim 17, further comprising set of instructions; and
wherein said system is arranged as a kit.

19. A method of using a trestle ladder system, the method comprising the steps of:
providing a trestle ladder system comprising at least two ladder assemblies, at least one plank assembly, and a handrail assembly;
placing said at least two ladder assemblies of said trestle ladder system adjacent to a work surface;
placing said plank assembly upon said ladder assemblies;
affixing said handrail assembly to said ladder assemblies; and
completing a work-related task.

20. The method of claim 19, further comprising the steps of:
removing said handrail assembly from said ladder assemblies;
removing said plank assembly from said ladder assemblies; and
removing said trestle ladder system.
